(19) United States
(12) Patent Application Publication
(10) Pub. No.: US 2018/0188457 A1
(43) Pub. Date: Jul. 5, 2018

(54) OPTICAL COMMUNICATION MODULE CONFIGURED FOR ENHANCING OPTICAL COUPLING EFFICIENCY

(71) Applicant: LUXNET CORPORATION, Zhongli City (TW)

(72) Inventors: Pi-Cheng Law, Zhongli City (TW); Po-Chao Huang, Zhongli City (TW); Po-Sung Liu, Zhongli City (TW); Hsing-Yen Lin, Zhongli City (TW); Hua-Hsin Su, Zhongli City (TW)

(21) Appl. No.: 15/822,519

(22) Filed: Nov. 27, 2017

(30) Foreign Application Priority Data
Dec. 30, 2016 (TW) 105220103
Feb. 3, 2017 (TW) 106201717

(51) Int. Cl. G02B 6/42; G02B 6/14; G02B 6/02; G02B 6/32

(52) U.S. Cl. CPC G02B 6/4206; G02B 6/4243; G02B 6/4228; G02B 6/32; G02B 6/02042; G02B 6/4212; G02B 6/14

(57) ABSTRACT

An optical communication module configured for enhancing optical coupling efficiency, which includes an optical butt joint receptacle and a light emitting body provided on one side of the optical butt joint receptacle. The optical butt joint receptacle has a receptacle body and a through hole provided in the receptacle body for a dual-core optical fiber to extend through. The receptacle body has a light-receiving side and an optical fiber insertion groove corresponding respectively to two ends of the through hole. The light emitting body includes a housing, a laser semiconductor provided in the housing, and an aperture provided in one side of the housing for aligning with the through hole so as that the laser beam emitted by the laser semiconductor is optically coupled to the dual-core optical fiber. The dual-core optical fiber has different core diameters and numerical apertures to enhance the coupling efficiency and reduce the coupling loss in between with the external optical fiber.

### BACKGROUND OF THE INVENTION

### 1. Technical Field

The present invention relates to an optical communication module, especially to an optical communication module configured for enhancing optical coupling efficiency.

### 2. Description of Related Art

In an optical communication system, the numerical aperture (NA) of an optical fiber determines the range of angles over which the optical fiber can receive light and therefore must be considered when guiding a light beam into the optical fiber. A small-NA optical fiber can receive light over only a small range of angles and may present difficulties, or cause excessive loss, in optical coupling, thus limiting the tolerances of optical coupling positions and lowering the yield of the resulting module.

Generally, the fiber core of an optical fiber butt joint receptacle is composed of an SMF-28 single-mode optical fiber, whose numerical aperture (NA=0.14, with the optical signal wavelength being 1310 nm) and core diameter (8.2 pin) require a light-coupling lens and a laser element to be placed by a high-precision machine in order to increase the efficiency of optical coupling. SMF-28 is a standard, and hence low-cost, optical fiber, but its small numerical aperture and small core diameter tend to hinder optical coupling or incur great coupling loss.

In order to solve the above drawbacks, some of the packaging methods are to cut the end-face of the single-mode optical fiber core in the optical fiber butt joint receptacle to form an inclined plane so that the end-face can have a specific inclined angle for receiving the incident laser light deviating from the optical axis with a specific angle. In order to match the incident laser light angle with the specific angle of the end-face, it is necessary to obtain the relative maximum coupling power value via automatic light-coupling machine with 360 degree rotation platform. However, it is time-consuming and labor-intensive for obtaining the relative maximum coupling power value. Meanwhile, in order to obtain the best coupling power value, the light-receiving angle may shift horizontally, and such coupling may not meet the mechanical requirement. Moreover, sometimes the horizontal shifting still cannot satisfy the maximum coupling efficiency, so that it is necessary to tilt the end-face of the optical fiber having a specific angle to obtain the maximum coupling power. However, such method is contrary to the actual requirement of the general communication elements that are flat and sealed after coupling. In addition, if the angle of the incident laser light is very small or does not deviate from the optical axis angle but the end-face of the single-mode optical fiber core has a specific angle by cutting, parts of the light beam would fall into angles outside the specific cone angle and the actual maximum optical power value cannot be obtained. Therefore, it must be replaced by the single-mode optical fiber core having end-face without any inclined angle or with one of various inclined angles at such circumstances. Such trial-and-error angle matching is time-consuming and labor-intensive, and cannot enhance the production efficiency for the optical communication module.

In addition, standard multi-mode fiber, having large core diameter and high numerical aperture, is used in part of packaging methods so as to increase the tolerance of receiving larger laser spots and incident laser light deviating from the optical axis with a specific angle. Although such design increases the receiving area and angle of the incident plane and use of the multi-mode optical fiber as the external optical fiber can connect without lose, when connecting to the outer single-mode optical fiber, it is easy to cause greater loss at the junction of the fibers during signal transmission owing to the core diameter of the multi-mode fiber (fiber core) is larger than that of the single-mode optical fiber (external fiber).

### BRIEF SUMMARY OF THE INVENTION

The object of the present invention is to solve the optical coupling efficiency issues of the conventional optical fiber butt joint receptacles, which only have single core diameter.

To solve the optical coupling efficiency issues of the conventional optical fiber butt joint receptacles, whose fiber cores have only single core diameter, the present invention provides an optical communication module configured for enhancing optical coupling efficiency, comprising an optical butt joint receptacle and a light emitting body provided on a side of the optical butt joint receptacle. The optical butt joint receptacle includes a receptacle body and a through hole provided in the receptacle body for a dual-core optical fiber to extend through, wherein the receptacle body has a light-receiving side and an optical fiber insertion groove corresponding to two ends of the through hole respectively. The light emitting body includes a housing and a laser semiconductor provided in the housing, and an aperture provided in one side of the housing for aligning with the through hole so that a laser beam emitted by the laser semiconductor is optically coupled to the dual-core optical fiber. Therein, the dual-core optical fiber in the through hole comprises a light-receiving section and a light-coupling section with different core diameters, the light-receiving section has a larger core diameter than the light-coupling section so as to increase a light-receiving area of the light-receiving side at the light-receiving section for enhancing coupling efficiency, and the light-coupling section has a mode field diameter equal to that of an external optical fiber or has a core diameter not more than or being close to a core diameter of the external fiber so as to enhance coupling efficiency in between with the external optical fiber.

Further, the light-receiving section has a larger numerical aperture than that of the light-coupling section so as to increase the light-receiving angle of the light-receiving side.

Further, the core diameter of the light-coupling section is not more than 8.2 μm of the core diameter of the external optical fiber.

Further, the core diameter of the light-coupling section is not 2.7 μm more than the core diameter of the external optical fiber.

Further, the numerical aperture of the light-coupling section is not more than or is close to the numerical aperture of the external optical fiber.

Further, the numerical aperture of the light-coupling section is not more than 0.14 of the numerical aperture of the external optical fiber.

Further, the numerical aperture of the light-coupling section is not 0.046 more than the numerical aperture of the external optical fiber.

Further, the dual-core optical fiber is formed by joining the light-receiving section and the light-coupling section together as an integrated cone optical fiber through a fused conical taper method.

Further, the dual-core optical fiber is thermally expanded core fiber (TEC fiber) or stepwise transitional core fiber (STC fiber).

Further, the dual-core optical fiber is a linked optical fiber having coupling structure provided between the light-receiving section and the coupling receiving section.

Further, the coupling structure comprises: a concave sintered surface at one end of the light-receiving section that is adjacent to the light-coupling section and an index coupling material filled in interior of the concave sintered surface at one end of the light-receiving section and between the light-receiving section and the light-coupling section; and/or, a concave sintered surface at one end of the light-coupling section that is adjacent to the light-receiving section and an index coupling material filled in interior of the concave sintered surface at one end of the light-coupling section and between the light-receiving section and the light-coupling section.

Further, the coupling structure comprises: a concave sintered surface at one end of the light-receiving section that is adjacent to the light-coupling section and a condensing lens configured correspondingly to interior of the concave sintered surface at one end of the light-receiving section; and/or, a concave sintered surface at one end of the light-coupling section that is adjacent to the light-receiving section and a condensing lens configured correspondingly to interior of the concave sintered surface at one end of the light-coupling section.

Further, the coupling structure comprises: a flat cut surface formed at one end of the light-receiving section that is adjacent to the light-coupling section, a flat cut surface formed at one end of the light-coupling section that is adjacent to the light-receiving section, and a condensing lens configured between the two flat cut surfaces of the light-receiving section and the light-coupling section.

Further, the coupling structure comprises: a convex sintered surface at one end of the light-receiving section that is adjacent to the light-coupling section; or, a convex sintered surface at one end of the light-coupling section that is adjacent to the light-receiving section.

Further, an outer diameter of the light-receiving section is equal to that of the light-coupling section.

Further, a coupling lens is configured between the laser semiconductor and through hole so that the laser light of the laser semiconductor aligns with the dual-core optical fiber in the through hole through the light-receiving side.

Further, the difference between the core diameter of the light-receiving side and that of the light-coupling section is smaller than or equal to 107 μm.

Further, the numerical aperture of the light-receiving section is more than 0.105.

Further, the light-receiving is a multi-mode optical fiber and the light-coupling section is a single-mode optical fiber.

Therefore, the present invention has the following effectiveness comparing to the conventional techniques:

1. The present invention uses optical fibers with two different core diameters to enhance the coupling efficiency of the optical communication module, solving the problem of poor coupling efficiency of the optical core of the conventional optical fiber butt joint receptacle that has only single core diameter.

2. The present invention reduces the reflection loss between two different butt-jointed optical fibers and increases their optical coupling efficiency by forming a fused conical taper, or providing a coupling structure and an index coupling material between the two optical fibers.

### BRIEF DESCRIPTION OF THE SEVERAL VIEWS OF THE DRAWINGS

FIG. 1 is the schematic sectional view of the embodiment of the optical communication module of the present invention.

FIG. 2 is the schematic diagram of the light-receiving angle of the present invention.

FIG. 3 is the functional block diagram of the first embodiment of the present invention.

FIG. 4 is the schematic sectional view of the first embodiment of the present invention.

FIG. 5 is the functional block diagram of the second embodiment of the present invention.

FIG. 6 is the schematic sectional view of the second embodiment of the present invention.

FIG. 7 is the schematic sectional view of the third embodiment of the present invention.

FIG. 8 is the schematic sectional view of the fourth embodiment of the present invention.

FIG. 9 is the s schematic sectional view of the fifth embodiment of the present invention.

FIG. 10 is the schematic sectional view of the sixth embodiment of the present invention.

### DETAILED DESCRIPTION OF THE INVENTION

The detailed description and technical features of the present invention are as follows with the drawings of the present invention. Further, the drawings of the present invention are not obtained on the basis of the actual proportion in order for convenient description. Thus, the drawings and the proportion thereof do not limit the scope of the present invention.

The present invention proposes the optical fiber butt joint receptacle of an optical communication module by fitting two optical fibers of different numerical apertures and core diameters into the receptacle, in terms of increasing optical coupling efficiency on the light-receiving side and reducing coupling loss attributable to a mismatch in core diameter or mode field diameter between the two optical fibers and an external optical fiber.

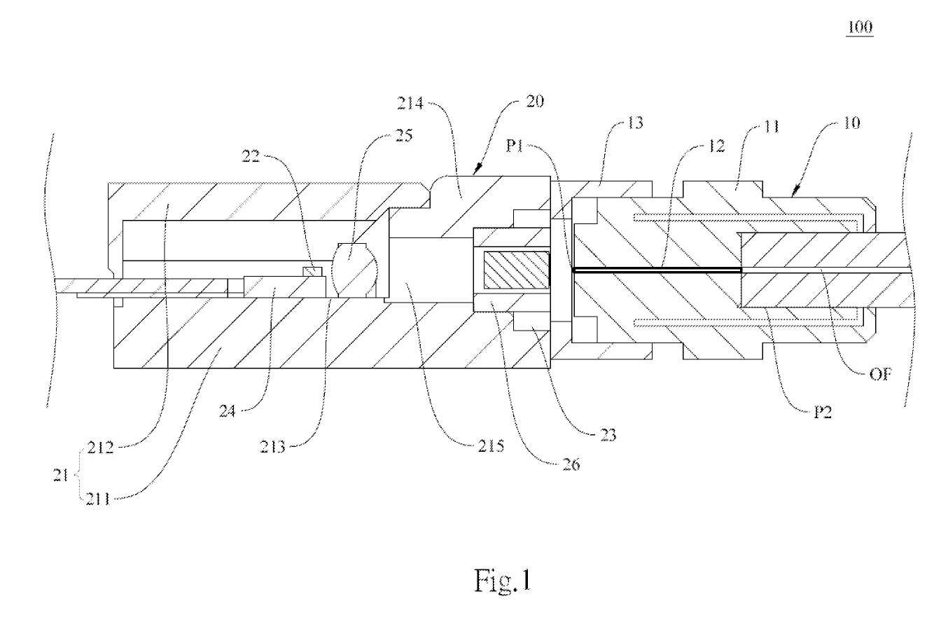

An embodiment of the present invention is described below with reference to FIG. 1, which is a schematic sectional view of the embodiment.

In this embodiment, an optical communication module 100 essentially includes an optical fiber butt joint receptacle 10 and a light-emitting body 20 provided on one side of the optical fiber butt joint receptacle 10.

The optical fiber butt joint receptacle 10 has a receptacle body 11, a through hole 12 provided in the receptacle body 11, and a Z-axis positioning cylinder 13 provided on one side of the receptacle body 11, wherein the through hole 12 is provided so that a dual-core optical fiber can extend through. The receptacle body 11 has a light-receiving side P1 and an optical fiber insertion groove P2 corresponding respectively to the two ends of the through hole 12.

The light-emitting body 20 includes a housing 21, a laser semiconductor 22 provided in the housing 21, and an aperture 23 provided in one side of the housing 21. The aperture 23 is aligned with the through hole 12 so that the laser beam emitted by the laser semiconductor 22 can be optically coupled to the dual-core optical fiber in the through hole 12 via a coupling lens 25. The housing 21 is divided into a base 211 and a cover 212 provided on the base 211. The upper side of the base 211 has a flat surface 213, on which a secondary base 24 and a coupling lens 25 are provided. The laser semiconductor 22 (or another optical communication element, e.g., a light-monitoring diode) is provided on the secondary base 24. A positioning platform 214 is provided on one side of the flat surface 213, perpendicular to the flat surface 213, and has a calibration hole 215 aligned with the laser semiconductor 22 in order for the laser beam emitted by the laser semiconductor 22 to pass through the calibration hole 215. The cover 212 serves to cover and thereby seal the aforesaid electronic components from topside so as to achieve the sealing effect. An optical isolator 26 is provided at the calibration hole 215 to isolate light beams reflected from the light-receiving side P1.

The packaging process of the optical communication module 100 begins by connecting the receptacle body 11 to the Z-axis positioning cylinder 13. Then, an optical coupling instrument (not shown) is used for calibration. Once the optical coupling instrument determines the optimal optical coupling positions of the receptacle body 11 and the Z-axis positioning cylinder 13 along the Z axis, the receptacle body 11 is secured to the Z-axis positioning cylinder 13 by electric welding or laser welding, and the distance from the light-receiving side P1 to the laser semiconductor 22 is thus fixed. After that, the Z-axis positioning cylinder 13 (connected with the receptacle body 11) is moved in the X-Y plane and is secured to the positioning platform 214 by electric welding or laser welding when the optimal optical coupling position is reached. As a result, relative positions of the receptacle body 11 and the calibration hole 215 in the X-Y plane are fixed.

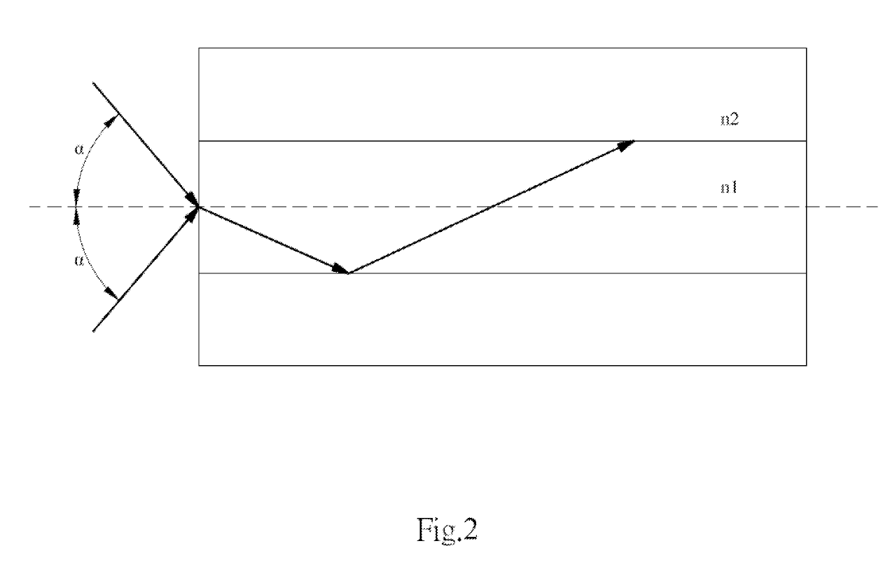

In the present invention, the dual-core optical fiber in the receptacle body 11 has two different core diameters. As stated above, the core diameter of an optical fiber determines the range of the light-receiving area. In a preferred embodiment, the dual-core optical fiber further has two different or similar numerical apertures. The numerical aperture of an optical fiber determines the light-receiving angle of the optical fiber. Basically, the numerical aperture (NA) value of an optical fiber depends on the refractive indices of the fiber core and the cladding surrounding the fiber core and can be expressed by the following equation (referring to FIG. 2):

NA=sin α=\sqrt{n₁²−n₂²}

where α is the light-receiving half-angle of the optical fiber, n₁ is the refractive index of the fiber core, and n₂ is the refractive index of the cladding. A light beam undergoes total internal reflection only when its angle of incidence is smaller than or equal to the light-receiving half-angle. The light-receiving angle, therefore, shows a positive correlation with optical coupling efficiency. Besides, after the laser beam emitted by the laser semiconductor 22 is focused by the coupling lens 25, the effective area of the resulting light spot is smaller than the light-receiving area, and this also helps raise optical coupling efficiency.

In order to increase light-receiving angle and light-receiving area, it is preferable that an optical fiber with a large numerical aperture and a large core diameter (e.g., a multi-mode optical fiber, or MMF) is used. However, when an optical fiber of a relatively large core diameter is connected to an optical fiber of a relatively small core diameter (e.g., a single-mode optical fiber, or SMF), the junction is prone to loss, which can be expressed by the following equation:

$$\{ \begin{matrix}- 20 {log}_{10} \frac{{D}_{2}}{{D}_{1}} , & {D}_{2} < {D}_{1} \\ 0 , & {D}_{2} \geq {D}_{1}\end{matrix}$$

where D₁ is the core diameter of the transmitting optical fiber, and D₂ is the core diameter of the receiving optical fiber. When the core diameter of the receiving optical fiber is larger than or equal to that of the transmitting optical fiber, loss between the two optical fibers approaches zero, if not counting the slight loss attributable to tolerances. Hence, the core diameter of the receiving optical fiber should not be smaller than that of the transmitting optical fiber.

When two optical fibers are butt-jointed, not only are their core diameters related to the efficiency of optical coupling between them, but also a mismatch in numerical aperture may cause coupling loss, which can be calculated by the following equation:

$$\{ \begin{matrix}- 20 {log}_{10} \frac{{NA}_{2}}{{NA}_{1}} , & {NA}_{2} < {NA}_{1} \\ 0 , & {NA}_{2} \geq {NA}_{1}\end{matrix}$$

NA₁ is the numerical aperture of the transmitting optical fiber, and NA₂ is the numerical aperture of the receiving optical fiber. When the numerical aperture of the receiving optical fiber is larger than or equal to that of the transmitting optical fiber, loss between the two optical fibers approaches zero, if not counting the slight loss attributable to tolerances. Therefore, the numerical aperture of the receiving optical fiber should not be smaller than that of the transmitting optical fiber.

Moreover, when a single-mode optical fiber is butt-jointed with another single-mode optical fiber, difference in mode field diameter (MFD) must be taken into account. If there is a difference in mode field diameter, optical coupling loss may take place between the optical fibers and can be determined by the following equation:

$$- 10 {log}_{10} \frac{\text{?}}{{( \frac{{ω}_{1}}{{ω}_{2}} + \frac{{ω}_{2}}{{ω}_{1}} )}^{2}}$$

$$\text{?} \text{indicates text missing or illegible when filed}$$

where ω₁ is the mode field diameter of the transmitting optical fiber, and ω₂ is the mode field diameter of the receiving optical fiber. In fact, only when the mode field diameter of the transmitting optical fiber approaches that of the receiving optical fiber will loss between the two optical fibers approach zero; otherwise (i.e., when the mode field diameter of the transmitting optical fiber is larger or smaller than that of the receiving optical fiber), loss is bound to occur.

Considering the aforesaid issues related to the light-receiving area and the light-receiving angle of optical fibers, a desirable approach for preventing optical communication module 100 of the present invention from optical coupling loss or output coupling loss is to use an optical fiber with a larger core diameter and numerical aperture on the light-receiving side (i.e., the side facing the laser semiconductor) of the dual-core optical fiber, and to use an optical fiber whose core diameter and numerical aperture are not larger than or are close to those of an external optical fiber or whose mode field diameter is the same as that of the external optical fiber, on the light-coupling side of the dual-core optical fiber (i.e., the side to couple with the external optical fiber).

Two more embodiments of the present invention are described below, in which the optical fiber in the receptacle body 11 (i.e., the optical fiber in the through hole 12) is a dual-core optical fiber with two different core diameters. By increasing the light-receiving area of the optical fiber portion on the light-receiving side P1, optical coupling efficiency is enhanced, and coupling loss resulting from a mismatch in core diameter or mode field diameter between the portion of the dual-core optical fiber that is on the side of the optical fiber insertion groove P2 and an external optical fiber OF is reduced.

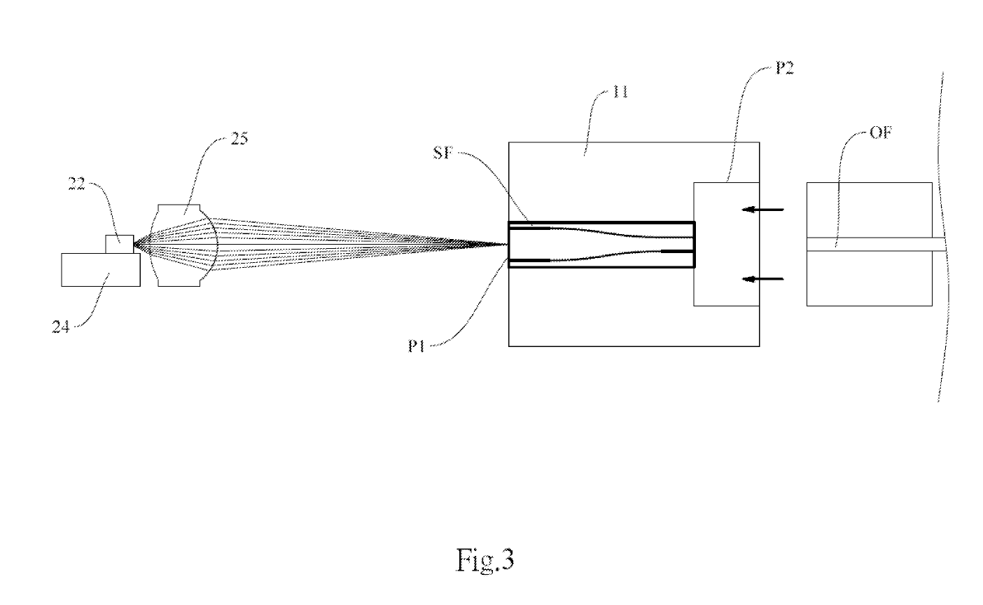

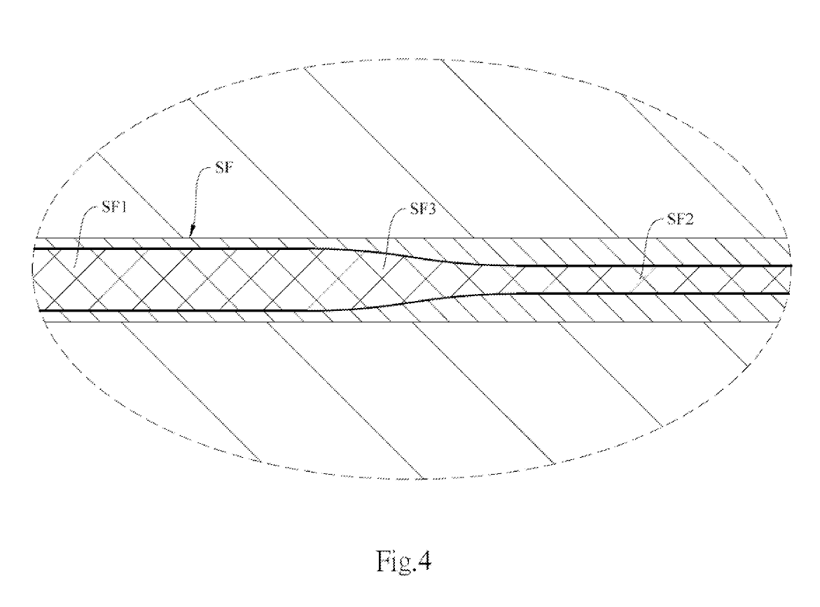

Referring to FIG. 3 and FIG. 4 respectively for a functional block diagram and a schematic sectional view of the first embodiment of the present invention.

In this embodiment, the dual-core optical fiber has a light-receiving section and a light-coupling section, which are joined together by a fused conical taper method to form a single unit cone optical fiber as a light-coupling section. To carry out the fused conical taper method, two optical fibers have to be prepared, and in this embodiment, an optical fiber with a relatively large core diameter (e.g., an MMF or a special SMF) and an optical fiber whose core diameter is not larger than or is close to that of the external optical fiber OF or whose mode field diameter is equal to that of the external optical fiber OF (e.g., an SMF) are required. The to-be-joined portions of the two optical fibers are fused together by being subjected to a temperature above 1400° C. but not higher than 1700° C. The fused and subsequently solidified portion of the two optical fibers is further exposed to high heat (controlled between about 1100° C. and 1200° C.) provided either by a flame produced by burning pure oxygen and hydrogen or by a high-temperature electric arc generated between the discharge electrodes of an electric arc generator. While being heated, the fused portion is also pulled on both sides by a stretching machine such that a semi-finished optical fiber with two different numerical apertures or core diameters is formed.

During the tapering process, the stretching force, distance, and time as well as the heat applied to the semi-finished optical fiber require proper adjustment, in order for the core of the optical fiber to reduce in diameter as a result of stretching. Eventually, a tapered optical fiber SF with a conical fiber core portion SF3 is formed. The conical fiber core portion SF3 can lower loss associated with reflection, thereby raising signal transmission rate and effectively reducing loss in optical power when a light beam undergoes the transition between two different core diameters.

By the method described above, two different optical fibers are joined as a single tapered optical fiber SF. The tapered optical fiber SF is fitted into the through hole 12 of the receptacle body 11 such that the portion composed of the optical fiber with a large core diameter (e.g., an MMF or a special SMF) functions as the light-receiving section SF1 adjacent to the light-receiving side P1. Meanwhile, the portion composed of the optical fiber whose core diameter or numerical aperture is not larger than or is close to that of the external optical fiber OF or whose mode field diameter is equal to that of the external optical fiber OF (e.g., an SMF) functions as the light-coupling section SF2 to be connected with the external optical fiber OF. The light-receiving section SF1 is optically coupled to the laser semiconductor 22 through the coupling lens 25 to increase the light-receiving angle and light-receiving area of the light-receiving side P1. The light-coupling section SF2 is intended to couple with the external optical fiber OF and can reduce coupling loss thanks to its mode field diameter being equal to that of the external optical fiber OF or its core diameter or numerical aperture being not larger than or being close to that of the external optical fiber OF. Preferably, the light-receiving section SF1 has a numerical aperture larger than 0.105 and a core diameter ranging from 7 μm to 110 μm; desirable light-receiving efficiency can be achieved within the aforesaid ranges. As the light-receiving angle increases with increasing numerical aperture, it should be understood that the values stated above are not limited. The light-coupling section SF2 preferably either has a mode field diameter equal to that of the external optical fiber OF or has a core diameter and numerical aperture that is not larger than or is close to that of the external optical fiber OF. Thus, not only is the optical fiber in the through hole 12 enhanced in optical coupling efficiency on the light-receiving side P1, but also the coupling loss between the optical fiber in the through hole 12 and the external optical fiber OF can be reduced. Here, the expression that the core diameter of the light-coupling section SF2 is close to that of the external optical fiber OF means that the former is not 2.7 μm more than the core diameter of the external optical fiber OF, such that loss can be controlled within a desirable range. If, however, it is desired to achieve acceptable coupling efficiency only, the core diameter of the light-coupling section SF2 should be not more than 8.2 μm of the core diameter of the external optical fiber OF. Further, the expression that the numerical aperture of the light-coupling section SF2 is close to that of the external optical fiber OF means that the former is not 0.046 more than the numerical aperture of the external optical fiber OF, such that loss can be controlled within a desirable range. If, however, it is desired to achieve acceptable coupling efficiency only, the numerical aperture of the light-coupling section SF2 should be not more than 0.14 of the numerical aperture of the external optical fiber OF.

In a preferred embodiment, the light-receiving section SF1 has a relatively large core diameter to increase the light-receiving area of the light-receiving side P1. Indeed, the structure of the conical fiber core portion SF3 allows the core diameter of the light-receiving section SF1 to be larger than or close to that of the light-coupling section SF2, but an overly large difference in core diameter may lead to excessive loss between the light-receiving section SF1 and the light-coupling section SF2. In a preferred embodiment, therefore, the difference between the core diameter of the light-receiving section SF1 and that of the light-coupling section SF2 is smaller than or equal to 107 μm to prevent such loss. The length and angle of the conical fiber core portion SF3 can be controlled within their respective desirable ranges when the difference in core diameter between the light-receiving section SF1 and the light-coupling section SF2 is smaller than or equal to 107 μm, the upper limit values, however, is not limited and should, in practice, take into account the requirements of product specifications.

Besides the above embodiment, the thermally expanded core fiber (TEC fiber) or the large core fiber (LCF) can also be combined with stepwise transitional core fiber (STC fiber) made by transitional fiber (TF) having different core diameters, or the LCF can be combined with single-mode optical fiber, to form a single optical fiber with two different numerical apertures and core diameters by fused conical taper method or other process method that can produce such specific composite fiber. Such specific composite fiber replaces the tapered optical fiber SF in the through hole 12 of the receptacle body 11, and the present invention has no limitation to the particular composite fiber. In addition, the above optical fibers of the light-receiving section SF1 and the light light-coupling section SF2 are multi-mode optical fibers (MMF) and single-mode optical fibers (SMF) respectively for the description, however, the present invention has no limitation to the optical fiber, which means the variation and modification according to the present invention may still fall into the scope of the invention.

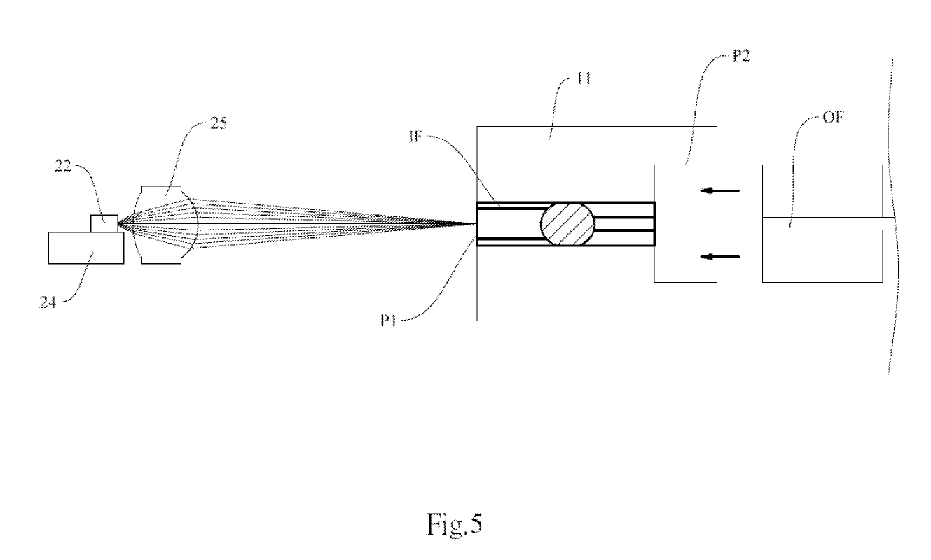

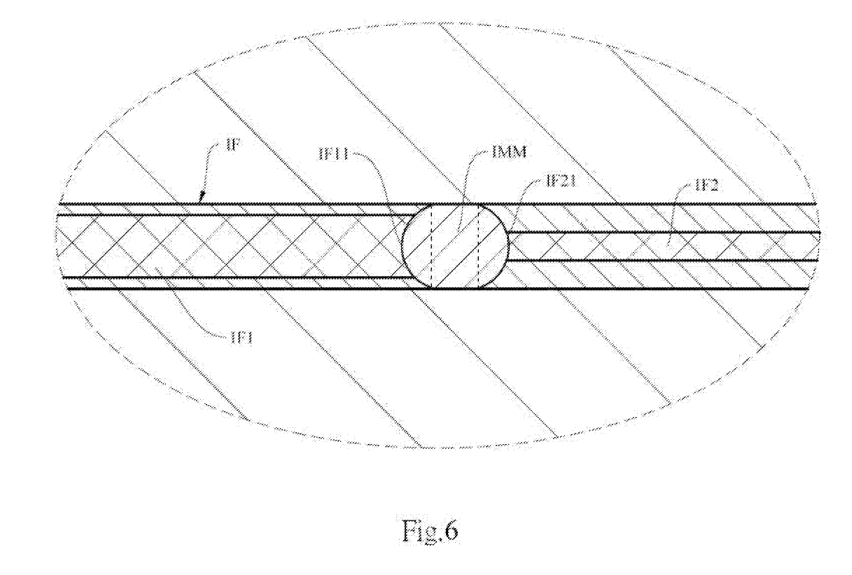

Another preferred embodiment of the present invention is described below with reference to FIG. 5 and FIG. 6, which are a functional block diagram and a schematic sectional view of the second embodiment respectively.

Unlike the previous embodiment, in which a single tapered optical fiber SF is fitted into the through hole 12 of the receptacle body 11, the dual-core optical fiber in the preferred embodiment includes a coupling structure provided between the light-receiving section IF1 and the light-coupling section IF2 such that a linked optical fiber IF with different numerical apertures or core diameters is formed. More specifically, optical fibers of different numerical apertures or core diameters are fitted into the through hole 12 to serve as the light-receiving section IF1 and the light-coupling section IF2 respectively. The coupling structure between the light-receiving section IF1 and the light-coupling section IF2 is configured to concentrate the light beam propagating through the light-receiving section IF1 so that the concentrated light beam can be coupled to the light-coupling section IF2, which has the smaller core diameter.

In the case where the light-receiving section IF1 has a larger core diameter than the light-coupling section IF2, a mismatch in core diameter between the input optical fiber (e.g., an MMF), which has the larger core diameter, and the output optical fiber (e.g., an SMF), which has the smaller core diameter, may cause loss (mismatch loss) during light beam transmission. To prevent such loss, a preferred embodiment is designed so that the end of the light-receiving section IF1 that is adjacent to the light-coupling section IF2 has a concave (i.e., curved from the outer edge of the optical fiber toward the interior of the optical fiber) sintered surface IF11, and that the end of the light-coupling section IF2 that is adjacent to the light-receiving section IF1 has a concave (i.e., curved from the outer edge of the optical fiber toward the interior of the optical fiber) sintered surface IF21. The concave surfaces IF11 and IF21 are connected by an index coupling material IMM that is filled in the gap between the concave surfaces IF11 and IF21 and forms a biconvex lens. The biconvex lens can focus the light beam in the light-receiving section IF1 on the core of the light-coupling section IF2 to prevent coupling loss attributable to the core diameter difference. In this embodiment, the refractive index of the index coupling material IMM should be higher than those of the light-receiving section IF1 and the light-coupling section IF2 in order for the index coupling material IMM to focus light on a fiber core.

Alternatively, it is feasible that only one of the concave surfaces IF11 and IF21 is provided, e.g., formed at the aforesaid end of one of the optical fibers (i.e., either the light-receiving section IF1 or the light-coupling section IF2), and in that case, the index coupling material IMM forms a plano-convex condensing lens instead. The present invention imposes no limitation on whether there is one or two concave surfaces or whether the index coupling material IMM forms a biconvex or plano-convex lens.

To effectively couple the light beam in the light-receiving section IF1 to the light-coupling section IF2, the curvatures of the concave surfaces IF11 and IF21 should not only match the difference in core diameter between the light-receiving section IF1 and the light-coupling section IF2, but also take into account the distance between the light-receiving section IF1 and the light-coupling section IF2, wherein the core diameter difference is highly correlated to the curvatures and spacing of the concave surfaces IF11 and IF21. In a preferred embodiment, the light-receiving section IF1 has a relatively large core diameter to increase the light-receiving area of the light-receiving side P1. The coupling structure allows the core diameter of the light-receiving section IF1 to be larger than or close to that of the light-coupling section IF2, and yet an overly large difference in core diameter may result in excessive loss between the light-receiving section IF1 and the light-coupling section IF2. In a preferred embodiment, such excessive loss is prevented by keeping the core diameter difference between the light-receiving section IF1 and the light-coupling section IF2 smaller than or equal to 107 μm. The curvatures of the concave surfaces IF11 and IF21 and the distance between the light-receiving section IF1 and the light-coupling section IF2 can be controlled within their respective desirable ranges when the core diameter difference is smaller than or equal to 107 μm, the upper limit value, however, is not limited and should, in practice, take the requirements of product specifications into consideration.

According to the above, two optical fibers with different numerical apertures and core diameters can be fitted into the same through hole 12 as separate optical fibers, wherein the optical fiber with the larger core diameter and numerical aperture (e.g., an MMF) serves as the light-receiving section IF1 adjacent to the light-receiving side P1 while the optical fiber whose mode field diameter is equal to that of the external optical fiber OF or whose core diameter or numerical aperture is not larger than or is close to that of the external optical fiber OF (e.g., an SMF) serves as the light-coupling section IF2 to couple with the external optical fiber OF. The light-receiving section IF1 is optically coupled to the laser semiconductor 22 via the coupling lens 25 to increase the light-receiving angle and light-receiving area of the light-receiving side P1. The light-coupling section IF2, on the other hand, is configured to couple with the external optical fiber OF. The concave surfaces IF11 and IF21 between the light-receiving section IF1 and the light-coupling section IF2 make it possible to optically couple the two optical fibers of different core diameters at higher efficiency and with less coupling loss. Preferably, the light-receiving section IF1 has a numerical aperture larger than 0.105 and a core diameter ranging from 7 μm to 110 μm, and the light-coupling section IF2 either has a mode field diameter equal to that of the external optical fiber OF or has a core diameter or numerical aperture that is not larger than or is close to that of the external optical fiber OF. Thus, not only is optical coupling efficiency enhanced on the light-receiving side P1, but also the coupling loss between the optical fibers in the through hole 12 and the external optical fiber OF can be reduced. Here, the expression that the core diameter of the light-coupling section IF2 is close to that of the external optical fiber OF means that the former is not 2.7 μm more than the core diameter of the external optical fiber, such that, loss can be controlled within a desirable range. If, however, it is desired to achieve acceptable coupling efficiency only, the core diameter of the light-coupling section IF2 should be not more than 8.2 μm of the core diameter of the external optical fiber OF. Besides, the expression that the numerical aperture of the light-coupling section IF2 is close to that of the external optical fiber OF means that the former is not 0.046 more than the numerical aperture of the external optical fiber OF, such that, loss can be controlled within a desirable range. If, however, it is desired to achieve acceptable coupling efficiency only, the numerical aperture of the light-coupling section IF2 should be not more than 0.14 of the numerical aperture of the external optical fiber OF.

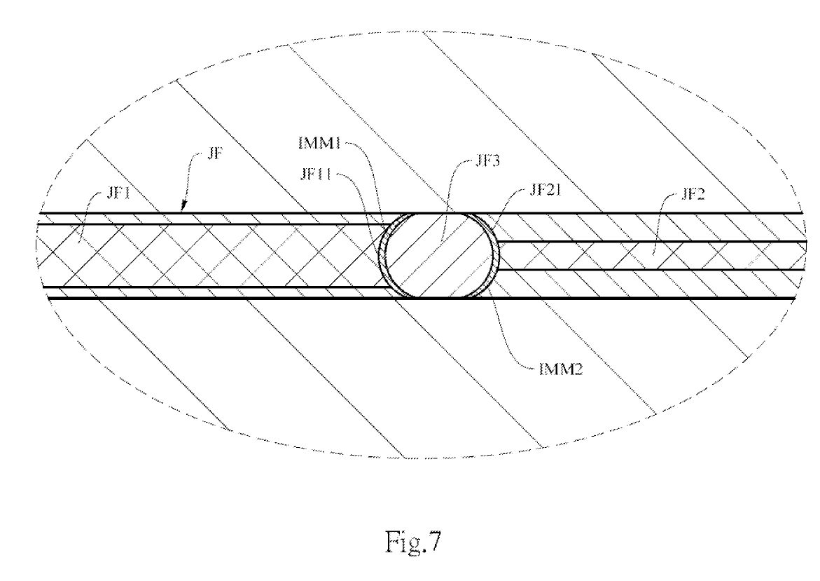

Referring now to FIG. 7 for a schematic sectional view of the third embodiment of the present invention.

This embodiment is different from the previous ones only in the way in which the coupling structure of the linked optical fiber is implemented, so the remaining portions will not be described repeatedly.

In this embodiment, the linked optical fiber JF has a light-receiving section JF1 and a light-coupling section JF2. The end of the light-receiving section JF1 that is adjacent to the light-coupling section JF2 has a concave sintered surface JF11. On the opposite side of this concave surface JF11, the light-coupling section JF2 has an end adjacent to the light-receiving section JF1 and formed with a concave sintered surface JF21. A condensing lens JF3 is provided between the concave surfaces JF11 and JF21 to focus the laser beam in the light-receiving section JF1 on the light-coupling section JF2, thereby reducing the coupling loss between the light-receiving section JF1 and the light-coupling section JF2.

More specifically, the condensing lens JF3 may be a biconvex lens. The curvatures of this biconvex lens match those of the concave surfaces such that the biconvex lens is tightly connected with the concave surfaces, forming a doublet at each of the tightly connected junctions. Each tightly connected junction includes an adhesive index coupling material IMM1 or IMM2 for creating an adhesive bond. Each tightly connected junction may alternatively be established by means of an externally applied force to compress JF1 and JF2 to form JF3, but an index coupling material is still required at each junction; that is, the index coupling materials IMM1 and IMM2 must be filled in the gaps between the concave surfaces JF11, JF21 and the condensing lens JF3 respectively. In this embodiment, the cores of the light-receiving section JF1 and the light-coupling section JF2 should have lower refractive indices than the condensing lens JF3. Preferably, the refractive index of the index coupling material IMM1, which is adjacent to the light-receiving section JF1, is higher than or equal to that of the light-receiving section JF1, and the refractive index of the index coupling material IMM2, which is adjacent to the light-coupling section JF2, is lower than or equal to that of the condensing lens JF3 to enable the light concentration. The refractive indices of the index coupling materials IMM1 and IMM2 being close to those of the adjacent materials (e.g., the cores and the condensing lens) also helps reduce reflection loss when a light beam passes through the index coupling materials IMM1 and IMM2 and the adjacent materials. The light condensing effect can be produced by various combinations of refractive indices (i.e., the refractive indices of the index coupling materials IMM1 and IMM2, of the cores of the light-receiving section JF1 and the light-coupling section JF2, and of the condensing lens JF3); the present invention has no limitation in this regard.

Moreover, it is feasible that only one of the concave surfaces JF11 and JF21 is provided, e.g., formed at the aforesaid end of one of the optical fibers (i.e., either the light-receiving section JF1 or the light-coupling section JF2), and in that case, a plano-convex condensing lens is provided on the concave surface. The present invention imposes no limitation on whether there is one or two concave surfaces or whether a biconvex or plano-convex lens is used.

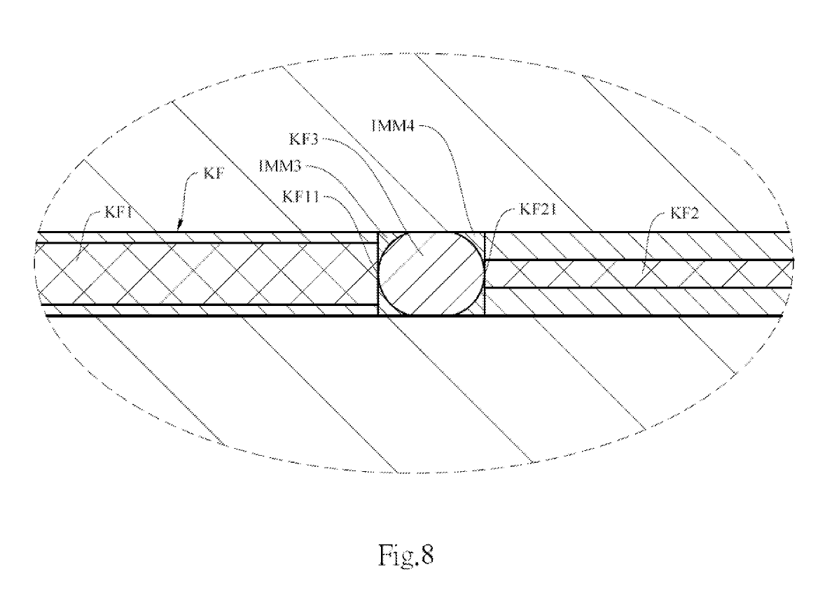

FIG. 8 shows a schematic sectional view of the fourth embodiment of the present invention.

This embodiment is different from the previous ones only in the way in which the coupling structure of the linked optical fiber is implemented, so the remaining portions will not be described repeatedly.

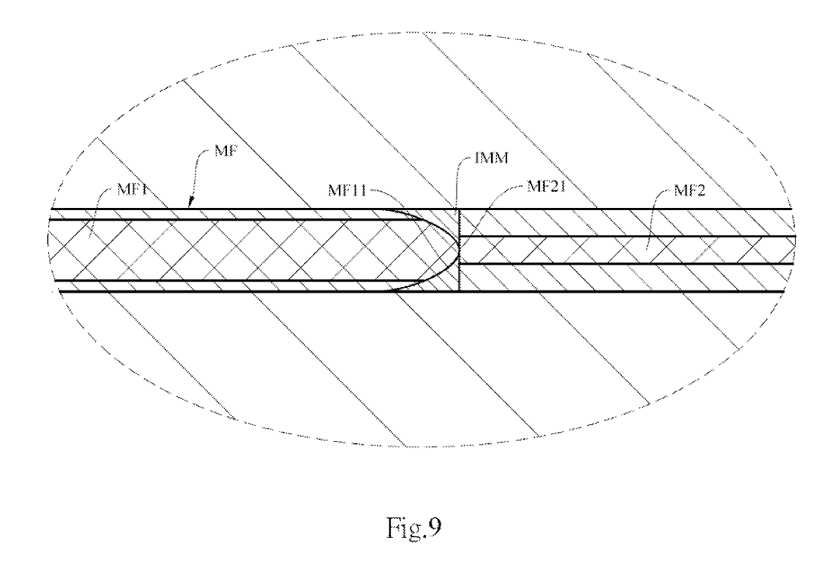

As shown in FIG. 8, the linked optical fiber KF includes a light-receiving section KF1 and a light-coupling section KF2. The end of the light-receiving section KF1 that is adjacent to the light-coupling section KF2 has a flat cut surface KF11, and the end of the light-coupling section KF2 that is adjacent to the light-receiving section KF1 has another flat cut surface KF21. A condensing lens KF3 is provided between the flat cut surface KF11 of the light-receiving section KF1 and the flat cut surface KF21 of the light-coupling section KF2. In addition, index coupling materials IMM3 and IMM4 are filled in the gaps between the condensing lens KF3 and the two flat cut surfaces KF11 and KF21 respectively. The condensing lens KF3 makes the laser beam in the light-receiving section KF1 converge on the light-coupling section KF2, thereby lowering the power loss between the light-receiving section KF1 and the light-coupling section KF2. In this embodiment, the refractive indices of the light-receiving section KF1 and the light-coupling section KF2 should be lower than that of the condensing lens KF3. Preferably, the refractive index of the index coupling material IMM3, which is adjacent to the light-receiving section KF1, is lower than or equal to that of the light-receiving section KF1, and the refractive index of the index coupling material IMM4, which is adjacent to the light-coupling section KF2, is lower than or equal to that of the light-coupling section KF2. It should be pointed out, however, that the refractive index of the index coupling material IMM4 can be higher than that of the light-coupling section KF2 but should not be higher than that of the condensing lens KF3. The refractive indices of the index coupling materials IMM3 and IMM4 being close to those of the adjacent materials (e.g., the cores and the condensing lens) also help reduce reflection loss when a light beam passes through the index coupling materials IMM3 and IMM4 and the adjacent materials. The light condensing effect can be produced by various combinations of refractive indices (i.e., the refractive indices of the index coupling materials IMM3 and IMM4, of the cores of the light-receiving section KF1 and the light-coupling section KF2, and of the condensing lens KF3); the present invention has no limitation in this regard. Please refer now to FIG. 9 for the fifth embodiment of the present invention.

This embodiment is different from the previous ones only in the way in which the coupling structure of the linked optical fiber is implemented, so the remaining portions will not be described repeatedly.

In this embodiment, the linked optical fiber MF has a light-receiving section MF1 and a light-coupling section MF2. The end of the light-receiving section MF1 that is adjacent to the light-coupling section MF2 has a convex sintered surface MF11, and the light-coupling section MF2 has a flat cut surface MF21 opposite to the convex surface MF11. An index coupling material IMM is filled in the gap between the convex surface MF11 and the flat surface MF21. In this embodiment, the index coupling material IMM preferably has a lower refractive index than the core of the light-receiving section MF1, in order for the light beam in the light-receiving section MF1 to be concentrated. In addition, the refractive index of the index coupling material IMM being close to those of the adjacent materials (e.g., the cores) help reduce reflection loss when a light beam passes through the index coupling material IMM and the adjacent materials.

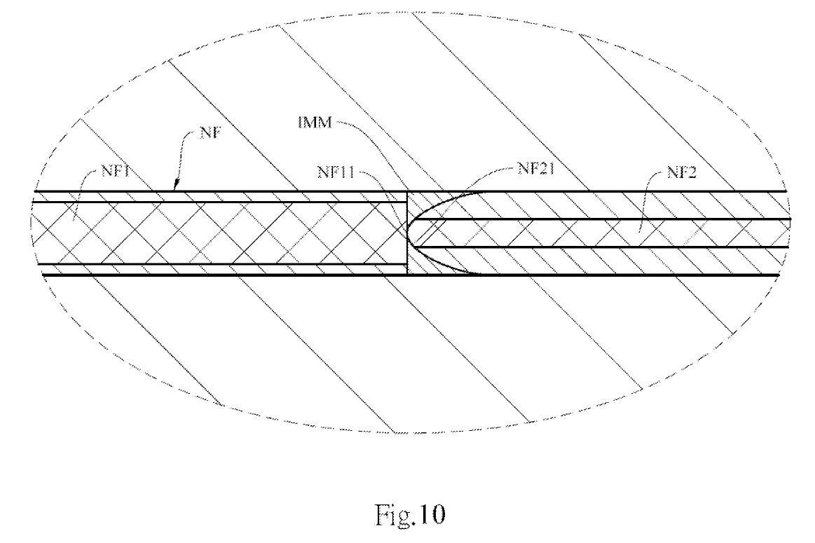

FIG. 10 shows a schematic sectional view of another preferred embodiment, or the sixth embodiment, of the present invention.

This embodiment is different from the previous ones only in the way in which the coupling structure of the linked optical fiber is implemented, so the remaining portions will not be described repeatedly.

The linked optical fiber NF disclosed in this embodiment has a light-receiving section NF1 and a light-coupling section NF2. The end of the light-coupling section NF2 that is adjacent to the light-receiving section NF1 has a convex sintered surface NF21, and the light-receiving section NF1 has a flat cut surface NF11 opposite to the convex surface NF21. An index coupling material IMM is filled in the gap between the convex surface NF21 and the flat surface NF11. In this embodiment, the refractive index of the index coupling material IMM is preferably lower than that of the core of the light-receiving section NF1, in order for the light beam in the light-receiving section NF1 to be concentrated. Also, the refractive index of the index coupling material IMM being close to those of the adjacent materials (e.g., the cores) helps reduce reflection loss when a light beam passes through the index coupling material IMM and the adjacent materials.

In another preferred embodiment, where the light-receiving section has a larger numerical aperture than the light-coupling section but the core diameter of the light-receiving section is close to or equal to that of the light-coupling section, an index coupling material is directly provided between the light-receiving section and the light-coupling section to reduce reflection loss at the interface, and there is no need to concentrate light through a conical fiber core portion, a lens, or a curved surface.

All the embodiments described above are capable of effectively joining two optical fibers that are different in numerical aperture and core diameter, in terms of increasing coupling efficiency and reducing reflection loss effectively. When applied to the optical fiber butt joint receptacle 10 of the optical communication module 100, the present invention not only provides the light-receiving side P1 with a large light-receiving angle and high light-receiving efficiency, but also enables the side where the optical fiber insertion groove P2 is located to deal with loss resulting from coupling with optical fibers of different mode field diameters (or core diameters). It should be understood that multi-mode optical fibers (MMFs) and single-mode optical fibers (SMFs) are used herein as the optical fibers in the light-receiving section and the light-coupling section by way of example only. The present invention imposes no limitation on the types of the optical fibers used. All substitutions and modifications that do not depart from the main spirit of the present invention should fall into the scope of the invention.

As above, the present invention uses optical fiber with two different core diameters to enhance the coupling efficiency of the optical communication module, solving the problem of poor coupling efficiency of the conventional optical fiber receptacle that has only single numerical aperture and core diameter. In addition, the present invention reduces the reflection loss between two different butt-jointed optical fibers and increases their optical coupling efficiency by forming a fused conical taper, or providing a coupling structure and an index coupling material, between the two optical fibers.

The above is the detailed description of the present invention. However, the above is merely the preferred embodiment of the present invention and cannot be the limitation to the implement scope of the present invention, which means the variation and modification according to the present invention may still fall into the scope of the invention.

What is claimed is:

1. An optical communication module configured for enhancing optical coupling efficiency, comprising:
an optical butt joint receptacle, including a receptacle body and a through hole provided in the receptacle body for a dual-core optical fiber to extend through, wherein the receptacle body has a light-receiving side and an optical fiber insertion groove corresponding to two ends of the through hole respectively; and
a light emitting body, provided on a side of the optical butt joint receptacle, wherein the light emitting body includes a housing and a laser semiconductor provided in the housing, and an aperture provided in one side of the housing for aligning with the through hole so that a laser beam emitted by the laser semiconductor is optically coupled to the dual-core optical fiber;
wherein the dual-core optical fiber in the through hole comprises a light-receiving section and a light-coupling section with different core diameters, the light-receiving section has a larger core diameter than the light-coupling section so as to increase a light-receiving area of a light-receiving side at the light-receiving section for enhancing coupling efficiency, and the light-coupling section has a mode field diameter equal to that of an external optical fiber or has a core diameter not more than or being close to a core diameter of the external fiber so as to enhance coupling efficiency in between with the external optical fiber.

2. The optical communication module of claim 1, wherein the light-receiving section has a larger numerical aperture than that of the light-coupling section so as to increase a light-receiving angle of the light-receiving side.

3. The optical communication module of claim 1, wherein the core diameter of the light-coupling section is not more than 8.2 μm of the core diameter of the external optical fiber.

4. The optical communication module of claim 3, wherein the core diameter of the light-coupling section is not 2.7 μm more than the core diameter of the external optical fiber.

5. The optical communication module of claim 1, wherein numerical aperture of the light-coupling section is not more than or is close to numerical aperture of the external optical fiber.

6. The optical communication module of claim 5, wherein the numerical aperture of the light-coupling section is not more than 0.14 of the numerical aperture of the external optical fiber.

7. The optical communication module of claim 6, wherein the numerical aperture of the light-coupling section is not 0.046 more than the numerical aperture of the external optical fiber.

8. The optical communication module of claim 1, wherein the dual-core optical fiber is formed by joining the light-receiving section and the light-coupling section together as an integrated cone optical fiber through a fused conical taper method.

9. The optical communication module of claim 1, wherein the dual-core optical fiber is thermally expanded core fiber (TEC fiber) or stepwise transitional core fiber (STC fiber).

10. The optical communication module of claim 1, wherein the dual-core optical fiber is a linked optical fiber having a coupling structure provided between the light-receiving section and the light-coupling section.

11. The optical communication module of claim 10, wherein the coupling structure comprises:
a concave sintered surface at one end of the light-receiving section that is adjacent to the light-coupling section, and an index coupling material filled in interior of the concave sintered surface at one end of the light-receiving section and between the light-receiving section and the light-coupling section; and/or,
a concave sintered surface at one end of the light-coupling section that is adjacent to the light-receiving section, and an index coupling material filled in interior of the concave sintered surface at one end of the light-coupling section and between the light-receiving section and the light-coupling section.

12. The optical communication module of claim 10, wherein the coupling structure comprises:
a concave sintered surface at one end of the light-receiving section that is adjacent to the light-coupling section, and a condensing lens configured correspondingly to interior of the concave sintered surface at one end of the light-receiving section; and/or,
a concave sintered surface at one end of the light-coupling section that is adjacent to the light-receiving section, and a condensing lens configured correspondingly to interior of the concave sintered surface at one end of the light-coupling section.

13. The optical communication module of claim 10, wherein the coupling structure comprises:
a flat cut surface formed at one end of the light-receiving section that is adjacent to the light-coupling section;
a flat cut surface formed at one end of the light-coupling section that is adjacent to the light-receiving section; and,
a condensing lens configured between the two flat cut surfaces of the light-receiving section and the light-coupling section.

14. The optical communication module of claim 10, wherein the coupling structure comprises:
a convex sintered surface at one end of the light-receiving section that is adjacent to the light-coupling section; or,
a convex sintered surface at one end of the light-coupling section that is adjacent to the light-receiving section.

15. The optical communication module of claim 1, wherein an outer diameter of the light-receiving section is equal to that of the light-coupling section.

16. The optical communication module of claim 1, wherein a coupling lens is configured between the laser semiconductor and through hole so that the laser light of the laser semiconductor aligns with the dual-core optical fiber in the through hole through the light-receiving side.

17. The optical communication module of claim 1, wherein the difference between the core diameter of the light-receiving side and that of the light-coupling section is smaller than or equal to 107 μm.

18. The optical communication module of claim 1, wherein the numerical aperture of the light-receiving section is more than 0.105.

19. The optical communication module of claim of 1, wherein the light-receiving section is a multi-mode optical fiber and the light-coupling section is a single-mode optical fiber.
